(19) United States
(12) Patent Application Publication
(10) Pub. No.: US 2026/0286606 A1
(43) Pub. Date: Sep. 24, 2026

(54) SYSTEM AND METHOD FOR CONTROLLING THE CLEANING OF A FEEDER HOUSING IN A HIGH-PRESSURE FEEDER

(71) Applicant: VALMET AB, Sundsvall (SE)

(72) Inventors: Robert CARLSTRÖM, Karlstad (SE); Roland BENGTSSON, Karlstad (SE)

(73) Assignee: VALMET AB, Sundsvall (SE)

(21) Appl. No.: 19/472,195

(22) PCT Filed: Apr. 19, 2024
(86) PCT No.: PCT/SE2024/050387

§ 371 Date: Oct. 3, 2025

(30) Foreign Application Priority Data
Apr. 24, 2023 (SE) 2330176-5

(51) Int. Cl. D21C 7/06; D21C 7/12

(52) U.S. Cl. CPC D21C 7/06; D21C 7/12

(57) ABSTRACT

A system for controlling the cleaning of a feeder housing in a high-pressure feeder includes: a high-pressure feeder including a housing that includes a tapered cylindrical chamber, the chamber having a drive end and an opposing tending end; a fluid conduit assembly operatively connected to the chamber, wherein the fluid conduit assembly includes a first conduit part configured to transport a first flow of cleaning fluid to the chamber via the tending end and a second conduit part configured to transport a second flow of cleaning fluid to the chamber via the drive end; a control valve configured to control the first flow of cleaning fluid; and a controller configured to receive a first input signal indicative of the initiation of a cleaning of the high-pressure feeder, and in response to the first input signal, control the control valve to reduce the first flow of cleaning fluid.

### TECHNICAL FIELD

The present invention relates to a system and a method for controlling the cleaning of a feeder housing in a high-pressure feeder.

### BACKGROUND

Making paper is a large industry, wherein paper is created by using pulp, which is manufactured from different raw materials containing cellulose. First the raw material is pre-processed and chipped into smaller pieces.

There are diverse ways to separate the wood fibre and create pulp for paper and cardboard, such as mechanical, thermomechanical, chemithermomechanical and chemical pulp. The most common way is chemical pulping, by using a chemical solution called white liquor that consists mainly of sodium hydroxide and sodium sulphide. This chemical is used to separate the lignin from the cellulose fibre. The woodchips are blended with the white liquor and then fed into a cooking vessel/boiler/digester to create pulp.

To feed the liquor and chips through the feeding line, a low-pressure feeder is typically used to push everything through the line without too much change in pressure. However, the cooking vessels/boilers/digesters are often very tall and to get the chips and white liquor to that height, a high-pressure feeder is used to pressurize it. The high-pressure feeder, which may be referred to as a high-pressure transfer device, is located upstream of either a cooking vessel/boiler/digester or an impregnation vessel, depending on the configuration of the feeding line. The high-pressure feeder thus transfers wood chips or similar cellulosic fibrous material in a liquid or other fluid, typically liquor/white liquor/cooking liquor, from the basing vessel or other vessel upstream of the high-pressure feeder to the cooking vessel/boiler/digester or the impregnation vessel.

The high-pressure feeder comprises a housing and a pocketed rotor, which is disposed in a chamber of the housing during operation and rotates within the housing chamber to transfer wood chips and liquid to the cooking vessel or impregnation vessel.

Liquid/fluid is continuously supplied to the feeder, for mixing with the wood chips during operation and for cleaning of the housing during the cleaning process. Cleaning of the housing may in this context also, e.g., be referred to as “cleaning process,” “flushing,” performing a “flush operation” of, “exercising,” performing an “exercise” of, or “purging” the high-pressure feeder, etc. During cleaning of the feeder housing, the pocket rotor is moved inside the housing chamber inwards and outwards in small incremental steps along the symmetry axis of the rotor. Thereby, the supplied cleaning liquid is enabled to flush out particles such as fines (small fibrous particles from wood chips) and scaling, i.e., particles that have stuck to the end bells of the chamber and resulted in a cake build-up on its inner walls. When the rotor is moved towards an end of the chamber, the rotation of the rotor agitates the fines, i.e., causes build-ups, or scaling, to be grinded and come loose from the inner wall of the end of the chamber. Then, when the rotor is moved slightly away from the same end of the housing, the loosened fines are flushed out by the cleaning liquid into the pocket rotor and out of the high-pressure outlet of the high-pressure feeder. The movement of the pocketed rotor back and forth is repeated a suitable number of times before the cleaning process is ended and operation of the high-pressure feeder is resumed.

A build-up of fines or other particles in the end bells of the housing tends to increase the rotational friction between the pocket rotor and the chamber, Thereby, the power load on the motor driving the high-pressure feeder increases, and wear of the rotor and housing components are increased. It is therefore crucial that the housing, especially the ends of the housing, which may be referred to as end bells or bell chambers, is properly cleaned before the rotor is reintroduced into its proper position and operation is resumed, to reduce the risk of cloggage, reduce the power needed to operate the feeder, and to maximize the lifespan of the components of the feeder. In other words, an insufficiently cleaned feeder will result in the problems of increased risk of cloggage, increased power needed to operate the feeder, increased wear of components of the feeder, and uneven wear of the feeder rotor.

Cloggage, as well as wear of components of the feeder that need to be maintained or replaced, lead to costly and time-consuming interruptions in operation.

Wear of components will lead to a reduced lifespan of the components and by extension to a reduced lifespan of the feeder.

Furthermore, uneven wear of the feeder rotor caused by the insufficient cleaning of the rotor, as well as increased power applied to operate the feeder, will result in a shorter rotor lifetime. It also leads to the feeder rotor adjustment stroke not being fully used.

Attempts have been made to solve these problems, for example in the related art patent document US 2009/014247 A1, which discloses a monitoring and adjustment system and method for a high-pressure feeder in a cellulose chip feeding system for a continuous digester and mentions the problem of fines collecting in the bell chambers, or ends, of the housing, and proposes cleaning, or purging, of the bell ends to address this problem in a common manner.

However, there is still a need for an improved cleaning of a feeder housing in a high-pressure feeder.

### SUMMARY

The object of the invention is to provide a solution for providing an improved cleaning of a feeder housing in a high-pressure feeder by controlling the supply of cleaning fluid during the cleaning process. This is achieved by a method and a system for controlling the cleaning of a feeder housing in a high-pressure feeder, according to the appended independent claims.

When a pocketed rotor is disposed in a housing of a high-pressure feeder, there is a gap between the housing and the rotor. As the inventors have realized, since the rotor, as well as the housing, is tapered and thereby has a greater diameter at the tending side (sometimes referred to as front side) compared to at the drive side, using the same gap between the rotor and the housing at the tending side and at the drive side leads to a greater flow at the tending side compared to at the drive side during rotation of the rotor. This in turn leads to the problem that the inner wall surface, or sealing surface, at the drive side of the housing more easily obtains a fibre cake build-up that is difficult to remove compared to the inner wall surface at the tending side of the housing. The build-up of fibre increases the drive power needed to drive the rotor (e.g., increased motor load or hydraulic pressure), and also increases the wear on the rotor at the drive side compared to at the tending side, thereby causing uneven wear of the rotor.

The inventors have thus realized that an improved flushing and cleaning result is achieved by focusing the flow of cleaning liquid or cleaning fluid (e.g., white liquor) to the side of the housing that has the greatest build-up of fibre. Solutions for achieving such improved control of the cleaning is provided by embodiments of the invention presented herein.

In a first aspect of the invention, there is provided a system for controlling the cleaning of a feeder housing in a high-pressure feeder, the system comprising a high-pressure feeder with a housing comprising a tapered cylindrical chamber configured to hold a tapered cylindrical pocketed rotor. The chamber has a drive end at the drive side of the housing and an opposing tending end at the tending side of the housing. The system further comprises a fluid conduit assembly operatively connected to the chamber, wherein the fluid conduit assembly comprises a first conduit part for transporting a first flow of cleaning fluid to the chamber via the tending end of the housing and a second conduit part for transporting a second flow of cleaning fluid to the chamber via the drive end of the housing, The system also comprises a control valve arranged on the first conduit part for controlling the first flow of cleaning fluid and a controller configured to receive a first input signal indicative of the initiation of a cleaning of the high-pressure feeder and, in response to the first input signal, control the control valve to reduce the first flow of cleaning fluid. That the controller is configured to control the control valve to reduce the first flow of cleaning fluid can mean that the controller is configured to choke the first flow of cleaning fluid.

Suitably, the flow, or supply, of cleaning fluid is thereby controlled such that the drive side of the housing is fed with a higher flow of fluid compared to the tending side of the housing. In other words, the flow of cleaning fluid is focused to the drive side, i.e., the side of the housing that has the greatest build-up of fibre, hence increasing the flow of cleaning liquid at the side of the housing where it is most needed to achieve efficient flushing results. Thereby an improved flushing and cleaning result is achieved compared to prior solutions. Advantageously, the improved cleaning thereby achieved before the rotor is reintroduced into its proper position and operation is resumed reduces the risk of cloggage, reduces the power needed to operate the high-pressure feeder, and decreases both wear and the risk of uneven wear of components of the high-pressure feeder. Wear of components will lead to a reduced lifespan of the components and by extension to a reduced lifespan of the feeder. Since the need for maintenance and replacements of system components is consequently reduced by embodiments herein, the present invention advantageously contributes to avoiding costly and time-consuming interruptions in operation, thereby saving both time and money.

The controller can be configured to receive a second input signal indicative of the end of the cleaning process and, in response to the second input signal, control the control valve to increase the first flow of cleaning fluid. That the controller is configured to control the control valve to increase the first flow of cleaning fluid will typically mean controlling the control valve to increase the first flow to the same flow, or close to the same flow, as the first flow before the cleaning process was initiated in response to the second input signal. This can mean to control the control valve to open fully. Alternatively, it can mean controlling the control valve to increase the first flow to a new desired flow level, if such a new level has been determined and input to the controller, e.g., as information comprised in the second input signal or via a separate input signal.

Suitably, the flow, or supply, of cleaning fluid in each of the first flow and second flow is thereby controlled to be at a desired (i.e., predetermined, regulated, or otherwise optimized) level before operation of the high-pressure feeder is resumed.

The fluid conduit assembly can further comprise a main conduit part for transporting a main flow of cleaning fluid to the chamber, wherein the main conduit part diverges into the first conduit part and the second conduit part, and the main flow of cleaning liquid is thereby divided into the first flow of cleaning liquid and the second flow of cleaning liquid. In this embodiment, controlling the control valve to reduce the first flow consequently simultaneously results in increasing the second flow. In other words, since the first and second flows originate from the same main flow, and the main flow is kept continuous at least during the cleaning process, the full or partial closing of the control valve will reduce, restrict, or even choke the first flow and at the same time increase the second flow. Thereby, the improved cleaning effect is achieved in an efficient manner because the additional advantages of achieving an increase in flow at the drive side is achieved without having to increase the total amount and flow of cleaning fluid provided to the housing. Instead, the already provided amount and flow of cleaning fluid (the main flow) is redirected to be focused on the drive end of the housing, where it will give the best cleaning effect.

Similarly, in this embodiment, controlling the control valve to increase the first flow simultaneously results in decreasing the second flow. Both the first flow and the second flow are preferably returned to the initial flow levels, i.e., the levels of the first flow and the second flow before the cleaning process was initiated, before operation of the high-pressure feeder is resumed.

In some of the embodiments wherein the fluid conduit assembly comprises a main conduit part that diverges into the first conduit part and the second conduit part, the first and second conduit parts are dimensioned such that the first flow and the second flow are equal (or as close to equal as possible within conduit manufacturing tolerances and any deviations due to wear of the first and second conduit parts and/or deposits etc. in the first and/or second conduit parts) during operation of the high pressure feeder, i.e. before the cleaning process is initiated. Thereby, the first flow of cleaning fluid to the chamber via the tending side is the same (or as close as possible) as the second flow of cleaning fluid to the chamber via the drive side during operation of the high-pressure feeder. In this embodiment the first flow of cleaning fluid to the chamber via the tending side is reduced or completely stopped during cleaning (if the control valve is choked), while the second flow of cleaning fluid to the chamber via the drive side is increased or even maximized (if the control valve is choked). Suitably, the cleaning capacity at the drive side of the housing, without adding additional cleaning fluid into the system or increasing the flow of the fluid using additional power consuming pumps or the like, is thereby optimized.

The system can further comprise an actuator that is operatively connected to the pocketed rotor comprised in the cylindrical chamber and configured to move said rotor along a longitudinal symmetry axis of the cylindrical chamber. The controller can be configured to control the actuator to adjust the position of the pocketed rotor along the longitudinal symmetry axis. If a first input signal is received in the controller during an adjustment of the rotor, the controller is in this embodiment also configured to control the actuator to interrupt the adjustment in response to the first input signal. Thereafter, cleaning of the high-pressure feeder including controlling the control valve according to any embodiment described herein can be performed. Suitably, the adjustment of the rotor is thereby automatically interrupted when/if the first input signal that indicates that it is time to clean the feeder housing is received in the controller. This is highly efficient, since only a single (the first) input signal is used to both interrupt the adjustment and initiate the cleaning process, in an automated manner.

If an adjustment of the pocketed rotor has been interrupted in response to the first input signal and a second input signal is then received in the controller, the controller can further be configured to, in response to receiving the second input signal, also control the actuator to continue the adjustment after controlling the control valve to increase the first flow of cleaning fluid. Suitably, the adjustment of the rotor is thereby automatically continued when/if the second input signal that indicates that the cleaning is done is received in the controller. Similar to the preceding automatic interruption of the adjustment this is highly efficient, since only a single (the second) input signal is used to both stop the cleaning process and continue the adjustment. Furthermore, thanks to the increased efficiency of cleaning achieved using embodiments of the present invention, the rotor may in many cases be adjusted further into the chamber after cleaning, i.e. before operation of the high-pressure feeder is resumed, compared to using prior art cleaning methods, because more of the fibre cake build-up is removed compared to the prior art cleaning methods. This is highly desirable, because otherwise the gap, or clearance, between the pocketed rotor and the surrounding chamber may become wider over time and exceed the acceptable upper threshold value, whereby there is an increased risk that pressure loss can occur in the fluid flowing through the high-pressure feeder during operation, leading to excessive fluid and fines flowing through the gap and accumulating in the housing, e.g., in the ends (end bells) of the housing, and excessive fluid may leak through to a low pressure outlet of the high pressure feeder.

The system can further comprise a flow meter operatively connected to the second conduit part for measuring a fluid flow of the second flow. The method can in this embodiment comprise determining if the flow in the second conduit part is below a pre-set lowest allowable threshold value for the respective flow (can be set to the same value or different values), The method can also comprise measuring a fluid flow of the first flow using an additional flow meter operatively connected to the first conduit part. The method can in this embodiment comprise determining if the flow in either or both of the first and second conduit part is below a priest lowest allowable threshold value for the respective flow (can be set to the same value or different values).

In a second aspect of the invention, there is provided a method for controlling the cleaning of a feeder housing in a high-pressure feeder, the high-pressure feeder comprising a housing with a tapered cylindrical chamber configured to hold a tapered cylindrical pocketed rotor, the chamber having a drive end at the drive side of the housing and an opposing tending end at the tending side of the housing, wherein the chamber is operatively connected to a fluid conduit assembly comprising a first conduit part for transporting a first flow of cleaning fluid to the chamber via the tending end of the housing and a second conduit part for transporting a second flow of cleaning fluid to the chamber via the drive end of the housing, and wherein a control valve is arranged on the first conduit part for controlling the first flow of cleaning fluid. The method comprises receiving, in a controller communicatively coupled to the control valve, a first input signal indicative of the initiation of a cleaning of the high-pressure feeder and, in response to receiving the first input signal, controlling the control valve, by the controller, to reduce the first flow of cleaning fluid. Controlling the control valve, by the controller, to reduce the first flow of cleaning fluid can comprise controlling the control valve to choke the first flow of cleaning fluid.

Suitably, the flow, or supply, of cleaning fluid is thereby controlled such that the drive side of the housing is fed with a higher flow of fluid compared to the tending side of the housing. In other words, the flow of cleaning fluid is focused to the drive side, i.e., the side of the housing that has the greatest build-up of fibre, hence increasing the flow of cleaning liquid at the side of the housing where it is most needed to achieve efficient flushing results. Thereby an improved flushing and cleaning result is achieved compared to prior solutions. Advantageously, the improved cleaning thereby achieved before the rotor is reintroduced into its proper position and operation is resumed reduces the risk of cloggage, reduces the power needed to operate the high-pressure feeder, and decreases both wear and the risk of uneven wear of components of the high-pressure feeder. Wear of components will lead to a reduced lifespan of the components and by extension to a reduced lifespan of the feeder. Since the need for maintenance and replacements of system components is consequently reduced by embodiments herein, the present invention advantageously contributes to avoiding costly and time-consuming interruptions in operation, thereby saving both time and money.

The method can further comprise receiving, in the controller, a second input signal indicative of the end of the cleaning process (i.e., that the cleaning process is done) and, in response to receiving the second input signal, controlling the control valve, by the controller, to increase the first flow of cleaning fluid. Controlling the control valve to increase the first flow of cleaning fluid will typically mean controlling the control valve to increase the first flow to the same flow, or close to the same flow, as the first flow before the cleaning process was initiated in response to the second input signal. This can mean controlling the control valve to open fully. Alternatively, it can mean controlling the control valve to increase the first flow to a new desired flow level, if such a new level has been determined and input to the controller, e.g., as information comprised in the second input signal or via a separate input signal.

Suitably, the flow, or supply, of cleaning fluid in each of the first flow and second flow is thereby controlled to be at a desired (i.e., predetermined, regulated, or otherwise optimized) level before operation of the high-pressure feeder is resumed.

The fluid conduit assembly can comprise a main conduit part for transporting a main flow of liquid cleaning fluid to the chamber, wherein the main conduit part diverges into the first conduit part and the second conduit part and the main flow of cleaning liquid is thereby divided into the first flow of cleaning liquid and the second flow of cleaning liquid, i.e. the main flow equals the first flow plus the second flow. In this embodiment, any method step comprising controlling the control valve to reduce the first flow consequently simultaneously results in increasing the second flow. In other words, since the first and second flows originate from the same main flow, and the main flow is kept continuous at least during the cleaning process, the full or partial closing of the control valve will reduce, restrict, or even choke the first flow and at the same time increase the second flow. Thereby, the improved cleaning effect is achieved in a more efficient manner, because the additional advantages of achieving an increase in flow at the drive side is achieved without having to increase the total amount and flow of cleaning fluid provided to the housing. Instead, the already provided amount and flow of cleaning fluid (the main flow) is redirected to be focused on the drive end of the housing, where it will give the best cleaning effect. Similarly, in this embodiment, any method step comprising controlling the control valve to increase the first flow simultaneously results in decreasing the second flow. Both the first flow and the second flow are preferably returned to the initial flow levels, i.e., the levels of the first flow and the second flow before the cleaning process was initiated, before operation of the high-pressure feeder is resumed.

In some of the embodiments wherein the fluid conduit assembly comprise a main conduit part that diverges into the first conduit part and the second conduit part, the first and second conduit parts are dimensioned such that the first flow and the second flow are equal (or as close to equal as possible within conduit manufacturing tolerances and any deviations due to wear of the first and second conduit parts and/or deposits etc. in the first and/or second conduit parts) during operation of the high-pressure feeder, i.e. before the cleaning process is initiated. Thereby, the first flow of cleaning fluid to the chamber via the tending side is the same (or as close as possible) as the second flow of cleaning fluid to the chamber via the drive side during operation of the high-pressure feeder. In this embodiment the first flow of cleaning fluid to the chamber via the tending side is reduced or completely stopped during cleaning (if the control valve is choked), while the second flow of cleaning fluid to the chamber via the drive side is increased or even maximized (if the control valve is choked). Suitably, the cleaning capacity at the drive side of the housing, without adding additional cleaning fluid into the system or increasing the flow of the fluid using additional power consuming pumps or the like, is thereby optimized.

In some embodiments, the method further comprises controlling an adjustment of the position of the tapered cylindrical pocketed rotor held in the tapered cylindrical chamber of the housing of the high-pressure feeder, before any of the above method steps are performed controlling. This is achieved by controlling, by the controller, an actuator that is operatively connected to the pocketed rotor comprised inside the cylindrical chamber and configured to move the pocketed rotor along a longitudinal symmetry axis of the cylindrical chamber to adjust the position of the pocketed rotor along the longitudinal symmetry axis. If the first input signal is received in the controller during such an adjustment, the method according to this embodiment comprises controlling the actuator to interrupt the adjustment in response to the first input signal. Thereafter, cleaning of the high-pressure feeder, including controlling of the cleaning according to any embodiment described herein, can be performed. Suitably, the adjustment of the rotor is thereby automatically interrupted when/if the first input signal, which indicates that it is time to clean the feeder housing, is received in the controller. This is highly efficient, since only a single (the first) input signal is used to trigger both the interruption of the adjustment and initiation of the cleaning process, in an automated manner.

The method embodiment comprises controlling an adjustment of the position of the tapered cylindrical pocketed rotor held in the tapered cylindrical chamber of the housing of the high-pressure feeder can further comprise, in response to receiving a second input signal as described herein, also controlling, by the controller, the actuator to continue the adjustment after controlling the control valve to increase the first fluid flow. Suitably, the adjustment of the rotor is thereby automatically continued when the second input signal, which indicates that the cleaning is done, is received in the controller. Similar to the preceding automatic interruption of the adjustment this is highly efficient, since only a single (the second) input signal is used to trigger both the stopping of the cleaning process and the subsequent continuation of the rotor adjustment, in an automated manner. Furthermore, thanks to the increased efficiency of cleaning achieved using embodiments of the present invention, the rotor may in many cases be adjusted further into the chamber after cleaning, i.e. before operation of the high pressure feeder is resumed, compared to using prior art cleaning methods, because more of the fibre cake build-up is removed compared to the prior art cleaning methods. This is highly desirable, because otherwise the gap, or clearance, between the pocketed rotor and the surrounding chamber may become wider over time and exceed the acceptable upper threshold value, whereby there is an increased risk that pressure loss can occur in the fluid flowing through the high-pressure feeder during operation, leading to excessive fluid and fines flowing through the gap and accumulating in the housing, e.g., in the ends (end bells) of the housing, and excessive fluid may leak through to a low pressure outlet of the high pressure feeder.

The method can further comprise measuring a fluid flow of the second flow using a flow meter operatively connected to the second conduit part. The method can in this embodiment comprise determining if the flow in the second conduit part is below a pre-set lowest allowable threshold value for the respective flow (can be set to the same value or different values). The method can also comprise measuring a fluid flow of the first flow using an additional flow meter operatively connected to the first conduit part. The method can in this embodiment comprise determining if the flow in either or both of the first and second conduit part is below a pre-set lowest allowable threshold value for the respective flow (can be set to the same value or different values).

Any advantage described in connection with the first aspect of the invention is equally applicable to corresponding embodiments of second aspects of the invention, and vice versa.

Many additional benefits and advantages of the present invention will be readily understood by the skilled person in view of the detailed description below.

### DRAWINGS

The invention will now be described in more detail with reference to the appended drawings, wherein:

FIG. 1 schematically discloses parts of a pulping system;

FIG. 2 schematically discloses a system for controlling the cleaning of a feeder housing in a high-pressure feeder according to embodiments of the invention;

FIG. 3 schematically discloses a system for controlling the cleaning of a feeder housing in a high-pressure feeder according to embodiments of the invention;

FIG. 4 schematically discloses a system for controlling the cleaning of a feeder housing in a high-pressure feeder according to embodiments of the invention;

FIG. 5 is a flow chart showing a method for controlling the cleaning of a feeder housing in a high-pressure feeder according to embodiments of the invention; and

FIG. 6 is a flow chart showing a method of performing an adjustment of the position of a pocketed rotor in a high-pressure feeder, including the method in FIG. 5 for controlling the cleaning of the feeder housing.

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

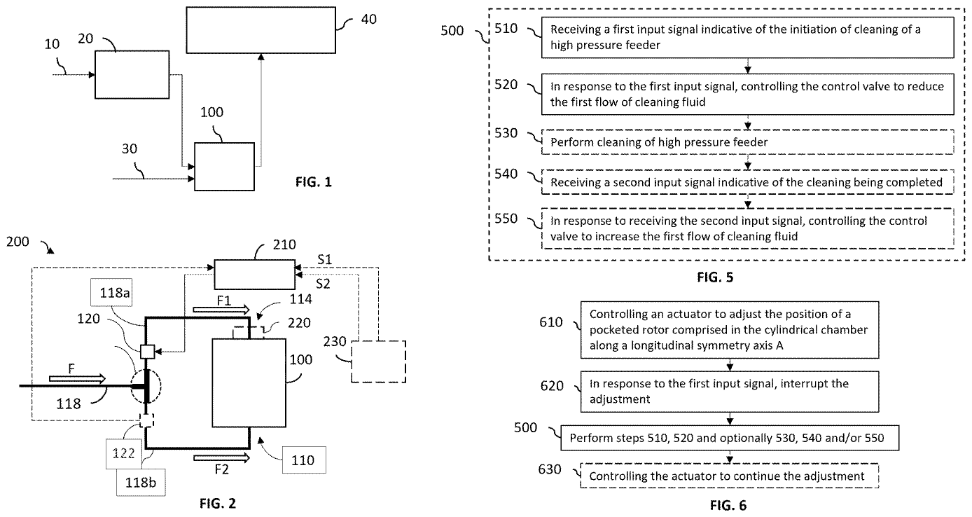

For reference, a greatly simplified schematic view of parts of the pulping system relevant to the present invention is first presented in connection with FIG. 1.

As shown in FIG. 1, wood chips 10 are passed through a basing vessel 20 before they enter the high-pressure feeder 100. Fluid 30, typically white liquor, is supplied to the high-pressure feeder 100 via a conduit assembly. The conduit assembly can, e.g., be the conduit assembly described in connection with FIGS. 2, 3 and 4 herein. The high-pressure feeder 100 comprises a housing and a rotor, which is disposed in the housing during operation and rotates within the housing to transfer wood chips 10 and fluid 30 to the cooking vessel or impregnation vessel 40. The fluid 30 is continuously supplied to the high-pressure feeder 100, for mixing with the wood chips during operation of the high-pressure feeder 100 and for cleaning of the housing during the cleaning process.

Cleaning of the housing may in this context also e.g., be referred to as “cleaning process,” “flushing,” performing a “flush operation” of, “exercising,” performing an “exercise” of, or “purging” the high-pressure feeder, etc. During cleaning of the feeder housing, the pocket rotor is moved inside the housing chamber inwards and outwards in small incremental steps along the symmetry axis of the rotor. Thereby, the supplied cleaning liquid is enabled to flush out particles such as fines (small fibrous particles from wood chips) and scaling, i.e., particles that have stuck to the end bells of the chamber and resulted in a cake build-up on its inner walls. When the rotor is moved towards an end of the chamber, the rotation of the rotor agitates the fines, i.e., causes build-ups, or scaling, to be grinded and come loose from the inner wall of the end of the chamber. Then, when the rotor is moved slightly away from the same end of the housing, the loosened fines are flushed out by the cleaning liquid into the pocket rotor and out of the high-pressure outlet of the high-pressure feeder. The movement of the pocketed rotor back and forth is repeated a suitable number of times before the cleaning process is ended and operation of the high-pressure feeder is resumed.

Cleaning may suitably be initiated and performed at certain times, e.g., at pre-set time intervals such as once or twice a week or another suitable time interval, or it may be initiated when a need to clean the housing is determined, for example based on information obtained from manual inspection and/or sensors measuring parameters indicative of a build-up of fines or the like inside the housing. Such parameters can include, but are not limited to, increased motor load, hydraulic pressure, increased wear of components, uneven wear/unbalanced components, increased vibrations, increased temperature, or other parameters indicative of increased friction between the pocketed rotor and the housing. Of course, cleaning of the high-pressure feeder can be initiated at pre-set times and additional cleaning may also be initiated if a need is determined in any other manner.

As the inventors have realized, since the rotor, as well as the housing, is tapered and thereby has a greater diameter at the tending side (sometimes referred to as front side) compared to at the drive side, using the same gap between the rotor and the housing at the tending side and at the drive side leads to a greater flow at the tending side compared to at the drive side during rotation of the rotor. This in turn leads to the problem that the inner wall surface, or sealing surface, at the drive side of the housing more easily obtains a fibre cake build-up that is difficult to remove compared to the inner wall surface at the tending side of the housing. The build-up of fibre increases the drive power needed to drive the rotor (e.g., increased motor load or hydraulic pressure), and also increases the wear on the rotor at the drive side compared to at the tending side, thereby causing uneven wear of the rotor. Therefore, a cleaning process, wherein cleaning fluid (e.g. white liquor) is provided to both the tending side and the drive side of the housing with the same, or similar, flow, is not as efficient in removing the fibre cake build-ups as if the flow is focused, i.e. the flow is increased during the cleaning process, at the drive side of the housing, because this is where the most fibre cake build-up will be located.

The object of the invention is to provide a solution for providing an improved cleaning of a feeder housing in a high-pressure feeder by controlling the supply of cleaning fluid during the cleaning process. The inventors have thus realized that an improved flushing and cleaning result is achieved by focusing the flow of cleaning liquid or cleaning fluid to the side of the housing that has the greatest build-up of fibre. To achieve this object, there is therefore provided a system and a method for controlling the cleaning of a feeder housing in a high-pressure feeder in such an improved manner.

As used herein, the term “operatively connected” is to be understood as parts of the invention being connected electronically (i.e. so that signals can be transmitted and/or received through a wire or through a wireless connection) and/or parts of the invention being connected mechanically so that a movement or force can be transmitted from one part to the other, for example transmitting a movement from an actuator to a pocketed rotor in a high pressure feeder. The term “operatively connected” can also to be understood as parts of the invention being in fluid connection so that a flow of fluid can be transported from one part to the other, for example from a part of a fluid assembly to a chamber of a high-pressure feeder, as described in connection with embodiments herein, or so that a flow in one part of a system can be measured by another part, as in the case of one or more flow meter enabled to measure the flow of fluid in a conduit part.

The term “tending side” as used herein is the side of a paper machine from which the paper machine is controlled, whereas the other side is denoted as a “drive side”.

It is noted that all sizes, angles, relations etc. given herein are not to be seen as only covering the exact given values but also include minor variations due to manufacturing tolerances. It is also to be noted that features from the various embodiments described herein may freely be combined, unless it is explicitly stated that such a combination would be unsuitable.

In a first aspect of the invention, a system 200 for controlling the cleaning of a feeder housing 102 in a high-pressure feeder 100 will first be described with reference to FIGS. 2, 3 and 4.

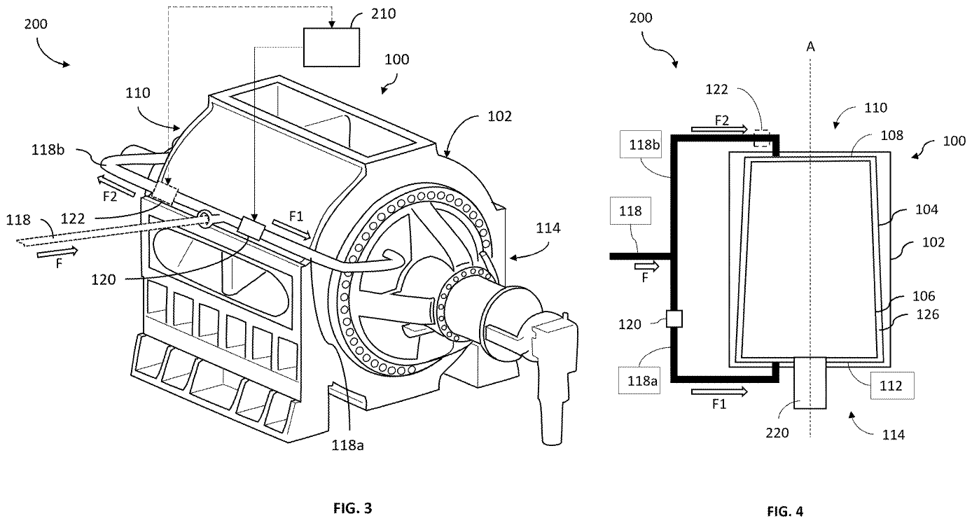

FIG. 2 shows a schematic view of a system 200 for controlling the cleaning of a feeder housing in a high-pressure feeder 100. FIG. 3 shows a schematic view of the same system 200, wherein a more detailed perspective view of the high-pressure feeder 100, in a non-limiting exemplary embodiment, is included. FIG. 4 shows a schematic view of the same system 200, wherein the high-pressure feeder 100 is shown as seen from the top of the high-pressure feeder and showing a cross-sectional view, to illustrate schematically the positioning of the inner parts of the housing 102, i.e., the tapered cylindrical chamber 104 and rotor 106, and how the components are positioned relative to the actuator 220 if this is included, and the longitudinal symmetry axis A. This is further described below.

As schematically shown in FIGS. 2, 3 and 4, the system 200 comprises a high-pressure feeder 100 with a housing 102 comprising a tapered cylindrical chamber 104 configured to hold a tapered cylindrical pocketed rotor 106. The chamber 104 has a drive end 108 at the drive side 110 of the housing 102 and an opposing tending end 112 at the tending side 114 of the housing 102. As can be seen from the top view cross section of FIG. 4, the diameter of the tapered cylindrical chamber 104 and the pocketed rotor 106 is smaller at the drive end 108 compared to at the tending end 112, leading to the uneven build-up of fines in the two ends of the chamber 104 in the housing 102 that is remedied by the improved cleaning of embodiments presented herein. The system 200 further comprises a fluid conduit assembly operatively connected to the chamber 104, wherein the fluid conduit assembly comprises a first conduit part 118a for transporting a first flow F1 of cleaning fluid to the chamber 104 via the tending end 112 of the housing 102 and a second conduit part 118b for transporting a second flow F2 of cleaning fluid to the chamber 104 via the drive end 108 of the housing 102. The system 200 also comprises a control valve 120 arranged on the first conduit part 118a for controlling the first flow F1 of cleaning fluid. The control valve 120 can be a throttle valve, a choke valve, a restrictor valve, or another valve configured to reduce, restrict and/or choke the flow of fluid. Of course, the control valve 120 can be a valve assembly comprising more than one valve, of any suitable type(s), working in combination to controlling the first flow F1 of cleaning fluid. The system further comprises a controller 210 configured to receive a first input signal S1 indicative of the initiation of a cleaning of the high-pressure feeder 100, and, in response to the first input signal S1, control the control valve 120 to reduce the first flow F1 of cleaning fluid. That the first input signal S1 is indicative of the initiation of a cleaning of the high-pressure feeder 100 means that it indicates that a cleaning process is about to be initiated. The controller 210 is thereby preferably enabled to control the control valve 120 to reduce the first flow F1 of cleaning fluid before or at the start of the cleaning process, so that the improved cleaning obtained by the embodiments herein is enabled during the entire cleaning process. The first input signal S1 can be generated and sent in response to manual input from an operator, for example via a user interface of an input device 230 communicatively connected to the system 200. Alternatively, or additionally, the first input signal S1 can be generated and sent automatically at pre-set times or time intervals. Alternatively, or additionally, the first input signal S1 can be generated and sent in response to an indication of fluid leakage exceeding an allowed threshold value. Other triggers are of course also conceivable.

In some embodiments, the controller 210 is configured to control the control valve 120 to choke, i.e., completely stop, the first flow F1 of cleaning fluid in response to the first input signal S1. The first input signal S1 can, beside the indication that a cleaning process is about to be initiated, also comprise more detailed information about to which degree the control valve 120 is to be controlled to reduce the first flow F1 or fluid. It is noted that during operation of the high-pressure feeder, before the first input signal is received, the control valve 120 is typically fully open, so that the first flow F1 is unrestricted.

The feed-flow control system 200 thus obtained enables controlling the first flow F1 of cleaning fluid such that the drive end 108 of the housing 102, i.e., the end of the housing that has the greatest build-up of fibre, is fed with an increased flow of cleaning fluid compared to the tending end 112. Thereby, an improved flushing and cleaning result of the drive end 108 is achieved.

Preferably, the fluid conduit assembly further comprises a main conduit part 118 for transporting a main flow F of liquid cleaning fluid to the chamber 104, wherein the main conduit part 118 diverges into the first conduit part 118a and the second conduit part 118b. Thereby, the main flow F of cleaning liquid is divided into the first flow F1 of cleaning liquid and the second flow F2 of cleaning liquid. In other words, in these embodiments F=F1+F2. The main conduit part 118 can diverge into the first and second conduit parts 118a, 118b via a t-pipe 124, as illustrated in the non-limiting examples of FIGS. 2, 3 and 4, or in any other suitable manner of dividing a single flow of fluid into two flows. Since the first and second flows F1, F2 originate from the same main flow F, and the main flow F is kept continuous at least during the cleaning, the full or partial closing of the control valve 120 will reduce, restrict, or even choke the first flow F1 and, at the same time, increase the second flow F2. In other words, in this embodiment controlling the control valve to reduce the first flow F1 consequently simultaneously results in increasing the second flow F2. Thereby, the improved cleaning effect on the drive side 108 of the housing 102 is achieved. Additionally, the advantages of achieving an increase in the second flow F2 at the drive end 108 is achieved without having to increase the total amount and flow of cleaning fluid provided to the chamber 104. Instead, the already provided amount and flow of cleaning fluid (the main flow F) is redirected to be more focused on the drive end 108 of the housing 102, where it will give the best cleaning effect.

In some of the embodiments wherein the fluid conduit assembly comprises the main conduit part 118 that diverges into the first conduit part 118a and the second conduit part 118b, the first and second conduit parts 118a, 118b are dimensioned such that the first flow F1 and the second flow F2 are equal (or as close to equal as possible within conduit manufacturing tolerances and any deviations due to wear of the first and second conduit parts and/or deposits etc. in the first and/or second conduit parts) during operation of the high-pressure feeder, i.e. before the cleaning process is initiated. Thereby, the first flow F1 of cleaning fluid to the chamber 104 via the tending side 114 is the same as (or as close as possible to) the second flow F2 of cleaning fluid to the chamber 104 via the drive side 110 during operation of the high-pressure feeder 100. In this embodiment, the first flow F1 of cleaning fluid to the chamber 104 via the tending side 114 is reduced or completely stopped (if the control valve 120 is choked) during cleaning, while the second flow F2 of cleaning fluid to the chamber 104 via the drive side 110 is increased or even maximized (if the control valve 120 is choked). Suitably, the cleaning capacity at the drive side 110 of the housing is thereby optimized, without the need to add additional cleaning fluid into the system 200 or increasing the flow of the fluid using additional power consuming pumps or the like.

The controller 210 can further be configured to receive a second input signal S2 indicative of the cleaning process being over and, in response to the second input signal S2, control the control valve 120 to increase the first flow F1 of cleaning fluid. That the second input signal S2 is indicative of the indicative of the cleaning process being over means that it indicates that the cleaning process is done or about to be done.

The second input signal S2 can be generated and sent in response to manual input from an operator, for example via a user interface of an input device 230 communicatively connected to the system 200. Alternatively, or additionally, the second input signal S2 can be generated and sent automatically, e.g., at a pre-set time after the initiation of the cleaning process or after a pre-set number of adjustments back and forth of the rotor 106. Other triggers are of course also conceivable.

That the controller 210 is configured to control the control valve 120 to increase the first flow F1 of cleaning fluid will typically mean controlling the control valve 120 to increase the first flow F1 to the same flow, or close to the same flow, as the first flow F1 before the cleaning process was initiated in response to the controller receiving the second input signal S2, e.g. controlling the control valve 120 to open fully if it was fully open before the first input signal S1 was received. Alternatively, it can mean controlling the control valve to increase the first flow F1 to a new desired flow level, if such a new level has been determined and input to the controller 210, e.g., as information comprised in the second input signal S2 or via a separate input signal.

Suitably, the flow, or supply, of cleaning fluid in each of the first flow F1 and second flow F2 is thereby controlled to be at a desired (i.e., predetermined, regulated, or otherwise optimized) level before operation of the high-pressure feeder 100 is resumed.

In embodiments including the main conduit part 118 diverging into the first and second conduit parts 118a, 118b, controlling the control valve 120 to increase the first flow F1 simultaneously results in decreasing the second flow F2. Both the first flow F1 and the second flow F2 are preferably returned to the initial flow levels, i.e., the levels that the respective first and second flows F1, F2 had before the cleaning process was initiated, before operation of the high-pressure feeder is resumed.

Advantageously, the improved cleaning achieved by any system embodiment presented in connection with FIG. 2, 3 or 4 herein, to be performed before the rotor 106 is reintroduced into its proper position and operation of the high-pressure feeder 100 is resumed, reduces the risk of cloggage, reduces the power needed to operate the high-pressure feeder 100, and decreases both wear and the risk of uneven wear of components of the high-pressure feeder. Wear of components will lead to a reduced lifespan of the components and by extension to a reduced lifespan of the feeder. Since the need for maintenance and replacements of system components is consequently reduced by embodiments herein, the present invention advantageously contributes to avoiding costly and time-consuming interruptions in operation, thereby saving both time and money.

As shown in FIG. 4, the system 200 can further comprise an actuator 220 configured to move the pocketed rotor 106 that is comprised in the cylindrical chamber 104 along a longitudinal symmetry axis A of the cylindrical chamber 104. The controller 210 is in this embodiment configured to control the actuator 220 to adjust the position of the pocketed rotor 106 along the longitudinal symmetry axis A. The controller is further configured to, in response to receiving the first input signal S1 in the controller 210 during such an adjustment of the pocketed rotor 106, control the actuator 220 to interrupt the adjustment. Thereafter, cleaning of the high-pressure feeder including controlling the control valve according to any embodiment described herein can be performed. Suitably, the adjustment of the rotor is thereby automatically interrupted when/if the first input signal S1, which indicates that it is time to clean the feeder housing 102 (the chamber 104 of the feeder housing 102), is received in the controller 210. This is highly efficient, since only a single input signal, i.e., the first input signal S1, is used to both interrupt the adjustment and initiate the cleaning process, in an automated manner.

The actuator 220 can suitably comprise a motor, of any suitable type, configured to move a motor driven shaft that is coupled to an end of the pocketed rotor 106 and is axially aligned with the pocketed rotor 106 along the longitudinal axis A. The system 200 in these embodiments further comprises a motor driven shaft that is coupled to an end of the pocketed rotor 106 and is axially aligned with the pocketed rotor 106. The actuator 220 can be controllable to move and hence adjust the position of the pocketed rotor 106 along the longitudinal symmetry axis A in response to an actuator control signal from the controller 210, wherein the actuator control signal is indicative of an adjustment to be performed. The tapered cylindrical pocketed rotor 106 is rotatably positioned in the tapered cylindrical chamber 104 with an annular gap 126 between the tapered cylindrical pocketed rotor 106 and the inner walls of the tapered cylindrical chamber 104, as illustrated in the cross-section view in FIG. 4. The rotor 106 is axially movable in the chamber 104, and when the position of the pocketed rotor 106 is adjusted in this manner, the size of the gap 126 between the pocketed rotor 106 and the cylindrical chamber 104 is thus adjusted. The controller 210 can in these embodiments in turn be configured to generate an actuator control signal indicative of an adjustment to be performed. The adjustment to be performed can relate to a desired position or change of position of the pocketed rotor 106, in relation to the cylindrical chamber 104, or a desired gap 126 or change of gap between the pocketed rotor 106 and the cylindrical chamber 104. The controller 210 can be configured to generate the actuator control signal based on input from an input device 230 communicatively connected to the system 200, as illustrated in FIG. 2. The input device 230 can, e.g., be a user-interface enabling a user to enter manual input, or at least one sensor configured to measure an operation parameter of the high-pressure feeder 100 that is indicative of a need to adjust the gap 126. Such operation parameters overlap with the parameters that indicate that a cleaning of the housing is needed and can include, but are not limited to, increased motor load, hydraulic pressure, increased wear of components, uneven wear/unbalanced components, increased vibrations, increased temperature, or other parameters indicative of increased friction between the pocketed rotor and the housing. Alternatively, or additionally, the controller 210 can be configured to generate the actuator control signal and thereby controlling the actuator 220 to perform an adjustment based on a time criterion. The time criterion can be that the adjustment is to be performed at one or more pre-set time, or that an adjustment is to be performed at pre-set time intervals.

If an adjustment of the pocketed rotor 106 has been interrupted in response to the first input signal S1 and a second input signal S2 is then received in the controller 210, the controller 210 can further be configured to, in response to the second input signal S2, also control the actuator 220 to continue the adjustment after controlling the control valve 120 to increase the first flow F1 of cleaning fluid. Suitably, the adjustment of the rotor 106 is thereby automatically continued when/if the second input signal S, which indicates that the cleaning is done, is received in the controller 210, Similar to the preceding automatic interruption of the adjustment this is highly efficient, since only a single (the second) input signal is used to both stop the cleaning process and continue the adjustment of the pocketed rotor 106. Furthermore, thanks to the increased efficiency of cleaning achieved using embodiments presented herein, the rotor 106 can in many cases be adjusted further into the chamber 104 after cleaning, i.e. before operation of the high-pressure feeder 100 is resumed, compared to using prior art cleaning methods, because more of the fibre cake build-up in the drive end 108 of the chamber 104 is removed compared to the prior art cleaning methods. This is highly desirable because otherwise the gap 126, or clearance, between the pocketed rotor 106 and the surrounding chamber 104 may become wider over time and exceed the acceptable upper threshold value, whereby there is an increased risk that pressure loss can occur in the fluid flowing through the high-pressure feeder 100 during operation, leading to excessive fluid and fines flowing through the gap 126 and accumulating in the chamber 104, e.g., in the ends (end bells), and excessive fluid may leak through to a low pressure outlet of the high-pressure feeder 100.

After cleaning, the controller 210 can be configured to receive measurements of the present motor load or hydraulic pressure, from sensors configured to measure these parameters, and determine, based on comparison of the received measurements to a reference value and/or a previous value, if the motor load is at an acceptable level and/or has been reduced compared to before the cleaning was performed. If the determination provides a positive response in either, or both, comparisons, the controller 210 is configured to determine that the cleaning was satisfactory.

Similarly, after adjustment of the rotor 106 comprising a cleaning process as described herein, the controller 210 can be configured to receive measurements of either the present motor load or hydraulic pressure, from sensors configured to measure these parameters, and/or a distance measurement indicative of the distance that the rotor 106 is introduced or adjusted into the chamber 104 after cleaning. The controller 210 is then configured to determine, based on comparison of the received motor load or hydraulic pressure measurements to a reference value and/or a previous value, if the motor load is at an acceptable level and/or has been reduced compared to before the cleaning was performed. Alternatively, or additionally, the controller 210 is configured to determine, based on comparison of the received distance value to a reference distance value and/or a previous distance value, if the rotor 106 is at an acceptable position inside the chamber 104 and/or if the distance has been reduced compared to before the cleaning was performed. If the determination provides a positive response in any of these comparisons, the controller 210 is configured to determine that the cleaning was satisfactory.

If the cleaning was not satisfactory according to any of the above comparisons, the controller can be configured to initiate an additional cleaning process and/or send information that further cleaning is needed to an operator of the system.

The system 200 can further comprise at least one flow meter 122 arranged in connection with and operatively connected to the second conduit part 118b for measuring a fluid flow of the second flow F2. The at least one flow meter 122 is configured to send measurements to the controller 210.

The controller 210 can then be configured to compare the received measurement, or several measurements received over time, from the flow meter 122 to a reference flow value (during operation, and possibly also comparing to another reference flow value during cleaning). If the measured flow value, or value over time, is lower than the reference value (e.g., compared to an exact desired reference value or such a reference value minus an allowable tolerance), the controller 210 can be configured to determine that the second conduit part 118b is clogged. The controller 210 can be configured to generate an alarm to an operator or the like, via a user interface of the input/output device 230 or in any suitable manner, based on such a determination.

In embodiments wherein the system 200 comprises the main conduit part 118 that diverges into the first and second conduit parts 118a, 118b, the at least one flow meter 122 can be configured to continuously measure the second flow F2 and send the measured values to the controller 210, whereby the controller 210 is configured to determine that an adjustment of the control valve 120 is needed. This determination can be based on if the second flow F2 deviates from a pre-set desired flow value (either an exact value or a value including an allowed tolerance), or if a comparison between the main flow F and the second flow F2 shows that the second flow F2 deviates from a pre-set relative value compared to F, e.g., but not limited to, F2=F2/2. If the controller 210 determines that an adjustment is needed, the controller 210 czn further be configured to generate and send a control signal to the control valve 120 to control the control valve 120 to make an appropriate adjustment.

Additionally, the system 200 can comprise at least one flow meter arranged in connection with and operatively connected to the first conduit part 118a for measuring a fluid flow of the first flow F1 and being configured to send measurements to the controller 210. The controller 210 can in these embodiments be configured to determine if the first conduit part is clogged based on measurements of the first flow F1 and comparisons to a reference value. The controller 210 can additionally, or alternatively, be configured to determine if adjustments of the control valve 120 is needed also based on measurements from the additional at least one flow meter. However, if the system 200 comprises the main conduit part 118, flow measurements on the first conduit part 118a are not necessary since the first flow F1 can be derived from the main flow F and the second flow F2. Possibly, it may still be of interest to include such redundant flow meters to enable double checking measurements performed by the at least one flow meter 122 of the second flow F2.

In a second aspect of the invention, a method for controlling the cleaning of a feeder housing in a high-pressure feeder will now be described in connection with FIGS. 5 and 6, also referring to FIGS. 2, 3 and 4.

FIG. 5 is a flow chart showing a method 500 for controlling the cleaning of a feeder housing in a high-pressure feeder according to embodiments of the invention. The high-pressure feeder 100 comprises a housing 102 with a tapered cylindrical chamber 104 configured to hold a tapered cylindrical pocketed rotor 106, the chamber 104 having a drive end 108 at the drive side 110 of the housing 102 and an opposing tending end 112 at the tending side 114 of the housing. The chamber 104 is operatively connected to a fluid conduit assembly comprising a first conduit part 118a for transporting a first flow F1 of cleaning fluid to the chamber 104 via the tending end 112 of the housing 102 and a second conduit part 118b for transporting a second flow F2 of cleaning fluid to the chamber 104 via the drive end 108 of the housing 102. A control valve 120 is arranged on the first conduit part 118a for controlling the first flow F1 of cleaning fluid. The method 500 illustrated in FIG. 5 comprises:
In step 510: receiving, in a controller 210 communicatively coupled to the control valve 120, a first input signal S1 indicative of the initiation of a cleaning of the high-pressure feeder 100.

That the first input signal S1 is indicative of the initiation of a cleaning of the high-pressure feeder 100 means that it indicates that a cleaning process is about to be initiated. Step 510 therefore preferably comprises controlling the control valve 120 to reduce the first flow F1 of cleaning fluid before or at the start of the cleaning process, so that the improved cleaning obtained by the embodiments herein is enabled during the entire cleaning process.

A first input signal S1 can be generated and sent in response to manual input from an operator, for example via a user interface of an input device 230 communicatively connected to the system 200. Alternatively, or additionally, a first input signal S1 can be generated and sent automatically at pre-set times or time intervals, from any suitable system component or external processing device. Alternatively, or additionally, a first input signal S1 can be generated and sent in response to an indication of fluid leakage exceeding an allowed threshold value. Other triggers are of course also conceivable. In some embodiments, the method can comprise generating and sending a first input signal S1 to the processor 210, according to any or all of these manners, before step 510.
In step 520: in response to the first input signal S1, controlling the control valve 120, by the controller 210, to reduce the first flow F1 of cleaning fluid.

Suitably, the flow, or supply, of cleaning fluid is thereby controlled such that the drive side 110 of the housing 102 is fed with a higher flow of fluid compared to the tending side 114 of the housing 102. In other words, the flow of cleaning fluid is focused to the drive end 108 of the chamber 104, i.e. the side of the housing 102, and hence the end of the chamber 104, that has the greatest build-up of fibre, meaning that the flow of cleaning liquid is focused at the side of the housing 102 where it is most needed to achieve efficient flushing results. Thereby an improved flushing and cleaning result is achieved.

Step 520 can comprise controlling the control valve 120, by the controller 210, to choke the first flow F1 of cleaning fluid.

The first input signal S1 can, beside the indication that a cleaning process is about to be initiated, also comprise more detailed information about to which degree the control valve 120 is to be controlled to reduce the first flow F1 or fluid. During operation of the high-pressure feeder, before the first input signal is received in step 510, the control valve 120 is typically fully open, so that the first flow F1 is unrestricted.

Preferably, the fluid conduit assembly, which is operatively connected to the chamber 104 of the high-pressure feeder 100 for which the cleaning controlling method of FIG. 5 is performed, further comprises a main conduit part 118 for transporting a main flow F of liquid cleaning fluid to the chamber 104, wherein the main conduit part 118 diverges into the first conduit part 118a and the second conduit part 118b. Thereby, the main flow F of cleaning liquid is divided into the first flow F1 of cleaning liquid and the second flow F2 of cleaning liquid. In other words, in these embodiments F=F1+F2. The main conduit part 118 can diverge into the first and second conduit parts 118a, 118b via a t-pipe 124, as illustrated in the non-limiting examples of FIGS. 2, 3 and 4, or in any other suitable manner of dividing a single flow of fluid into two flows. Since the first and second flows F1, F2 originate from the same main flow F, and the main flow F is kept continuous at least during the cleaning, the full or partial closing of the control valve 120 will reduce, restrict, or even choke the first flow F1 and at the same time increase the second flow F2. In other words, in this embodiment controlling the control valve to reduce the first flow F1 consequently simultaneously results in increasing the second flow F2. Thereby, the improved cleaning effect on the drive side 108 of the housing 102 is achieved. Additionally, the advantages of achieving an increase in the second flow F2 at the drive end 108 is thereby achieved without having to increase the total amount and flow of cleaning fluid provided to the chamber 104. Instead, the already provided amount and flow of cleaning fluid (the main flow F) is redirected to be more focused on the drive end 108 of the housing 102, where it will give the best cleaning effect. Of course, the total amount and/or flow of cleaning fluid provided to the chamber 104 may also be increased, in combination with the fluid flow control according to any aspect and embodiment of the invention, if this is desirable to, e.g., achieve even higher fluid flow at the drive end during the cleaning process or part of the cleaning process.

If the fluid conduit assembly comprises the main conduit part 118 that diverges into the first conduit part 118a and the second conduit part 118b, the first and second conduit parts 118a, 118b can be dimensioned such that the first flow F1 and the second flow F2 are equal (or as close to equal as possible within conduit manufacturing tolerances and any deviations due to wear of the first and second conduit parts and/or deposits etc. in the first and/or second conduit parts) during operation of the high-pressure feeder, i.e. before the cleaning process is initiated. Thereby, the first flow F1 of cleaning fluid to the chamber 104 via the tending side 114 is the same as (or as close as possible to) the second flow F2 of cleaning fluid to the chamber 104 via the drive side 110 during operation of the high-pressure feeder 100, which is common and often desirable. In this embodiment, step 520 comprises reducing or completely stopping (if the control valve 120 is choked) the first flow F1 of cleaning fluid to the chamber 104 via the tending side 114 during cleaning, while the second flow F2 of cleaning fluid to the chamber 104 via the drive side 110 is consequently correspondingly increased or even maximized (if the control valve 120 is choked). Suitably, the cleaning capacity at the drive side 110 of the housing is thereby optimized, without the need to add additional cleaning fluid into the system 200 or increasing the flow of the fluid using additional power consuming pumps or the like.

After the control method according to any of the embodiments presented in connection with steps 510 and 520, efficient cleaning of the high-pressure feeder 100 can then be performed in a step 530.

The method can further comprise optional steps 540 and 550, comprising:
In step 540: receiving, in the controller 210, a second input signal S2 indicative of the end of the cleaning process.

That the second input signal S2 is indicative of the end of the cleaning process can indicate that the cleaning is done, or that it is about to be done. The preceding method step 550 is thereby suitably performed just before or at the end of the cleaning process, i.e., when, or right before the high-pressure feeder resumes operation after the cleaning is completed.
In step 550: in response to receiving the second input signal S2, controlling the control valve 120, by the controller 210, to increase the first flow F1 of cleaning fluid.

Controlling the control valve 120 to increase the first flow F1 of cleaning fluid will typically mean controlling the control valve 120 to increase the first flow F1 to the same flow, or close to the same flow, as the first flow F1 before the cleaning process was initiated in response to the controller receiving the second input signal S2, e.g. controlling the control valve 120 to open fully if it was fully open before the first input signal S1 was received. Alternatively, it can mean controlling the control valve to increase the first flow F1 to a new desired flow level, if such a new level has been determined and input to the controller 210, e.g., as information comprised in the second input signal S2 or via a separate input signal.

Suitably, the flow, or supply, of cleaning fluid in each of the first flow F1 and second flow F2 is thereby controlled to be at a desired (i.e., predetermined, regulated, or otherwise optimized) level before operation of the high-pressure feeder 100 is resumed.

If the main conduit part 118, diverging into the first and second conduit parts 118a, 118b, is included in the fluid conduit assembly, then controlling the control valve 120 to increase the first flow F1 simultaneously results in decreasing the second flow F2. Both the first flow F1 and the second flow F2 are preferably returned to the initial flow levels, i.e., the levels that the respective first and second flows F1, F2 had before the cleaning process was initiated, before operation of the high-pressure feeder is resumed.

FIG. 6 is a flow chart showing a method of performing an adjustment of the position of a pocketed rotor 106 in a high-pressure feeder 100, including the method according to any of the embodiments described in connection with FIG. 5 for controlling the cleaning of the feeder housing 102. The method of FIG. 6 comprises:
In step 610: controlling, by the controller 210, an actuator 220 that is operatively connected to and configured to move the pocketed rotor 106 comprised in the cylindrical chamber 104 along a longitudinal symmetry axis A of the cylindrical chamber 104 to adjust the position of the pocketed rotor 106 along the longitudinal symmetry axis A.

The actuator 220 can be the actuator 220 according to any embodiment described in connection with the system 200.

Step 610 of controlling the actuator 220 to adjust the position of the pocketed rotor 106 can comprise receiving, in the actuator 220, an actuator control signal indicative of an adjustment to be performed from the controller 210 and adjust the position of the pocketed rotor 106 along the longitudinal symmetry axis A in response to the actuator control signal. The method can in these embodiments further comprise generating, by the controller 210, an actuator control signal indicative of an adjustment to be performed.

The adjustment to be performed can relate to a desired position or change of position of the pocketed rotor 106, in relation to the cylindrical chamber 104, or a desired gap 126 or change of gap between the pocketed rotor 106 and the cylindrical chamber 104.

Step 610 can comprise receiving, in the controller 210, input from an optional input device 230 communicatively connected to the system 200, as illustrated in FIG. 2, and generating the actuator control signal based on the input from the input device 230. The input device 230 can, e.g., be a user interface enabling a user to enter manual input, or at least one sensor configured to measure an operation parameter of the high-pressure feeder 100 that is indicative of a need to adjust the gap 126.

Such operation parameters overlap with the parameters that indicate that a cleaning of the housing is needed and can include, but are not limited to, increased motor load, hydraulic pressure, increased wear of components, uneven wear/unbalanced components, increased vibrations, increased temperature, or other parameters indicative of increased friction between the pocketed rotor and the housing. Alternatively, or additionally, step 610 can comprise generating, by the controller 210, the actuator control signal based on a time criterion. The time criterion can, e.g., be that the adjustment is to be performed at one or more pre-set times, or that an adjustment is to be performed at pre-set time intervals.
In step 620: in response to receiving in the controller 210 a first input signal S1 during an adjustment of step 610 also controlling, by the controller 210, the actuator 220 to interrupt the adjustment.

Suitably, the adjustment of the rotor is thereby automatically interrupted when/if the first input signal S1, which indicates that it is time to clean the feeder housing 102 (the chamber 104 of the feeder housing 102), is received in the controller 210. This is highly efficient, since only a single input signal, i.e., the first input signal S1, is used to both interrupt the adjustment and initiate the cleaning process, in an automated manner.
In step 500: Performing the method for controlling the cleaning of the feeder housing 102 according to any of the embodiments described in connection with FIG. 5.
In step 630: if steps 610, 620 and 500 have been performed, also controlling, by the controller 210, the actuator 220 to continue the adjustment in response to the second input signal S2, after controlling the control valve 120 to increase the first flow F1 of cleaning fluid.

Suitably, the adjustment of the rotor 106 is thereby automatically continued when/if the second input signal S2, which indicates that the cleaning is done, is received in the controller 210. Similar to the preceding automatic interruption of the adjustment this is highly efficient, since only a single (the second) input signal is used to both stop the cleaning process and continue the adjustment of the pocketed rotor 106. Furthermore, thanks to the increased efficiency of cleaning achieved using embodiments presented herein, the rotor 106 can in many cases be adjusted further into the chamber 104 after cleaning, i.e., before operation of the high-pressure feeder 100 is resumed, compared to using prior art cleaning methods, because more of the fibre cake build-up in the drive end 108 of the chamber 104 is removed compared to the prior art cleaning methods. This is highly desirable because otherwise the gap 126, or clearance, between the pocketed rotor 106 and the surrounding chamber 104 may become wider over time and exceed the acceptable upper threshold value, whereby there is an increased risk that pressure loss can occur in the fluid flowing through the high-pressure feeder 100 during operation, leading to excessive fluid and fines flowing through the gap 126 and accumulating in the chamber 104, e.g., in the ends (end bells), and excessive fluid may leak through to a low pressure outlet of the high-pressure feeder 100.

After cleaning, the method can further comprise receiving, in the controller 210, measurements of the present motor load or hydraulic pressure of the motor, from sensors configured to measure these parameters, and determine based on comparison of the received measurements to a reference value and/or a previous value if the motor load is at an acceptable level and/or has been reduced compared to before the cleaning was performed. If the determination provides a positive response in either, or both, comparisons, the controller 210 is configured to determine that the cleaning was satisfactory.

Similarly, after adjustment of the rotor 106 comprising a cleaning process as described herein, the controller 210 can be configured to receive measurements of either the present motor load or hydraulic pressure of the motor driving the high-pressure feeder, from sensors configured to measure these parameters, and/or a distance measurement indicative of the distance that the rotor 106 is introduced or adjusted into the chamber 104 after cleaning. The method then comprises determining, by the controller 210, if the motor load is at an acceptable level and/or has been reduced compared to before the cleaning was performed by comparing the received motor load or hydraulic pressure measurements to a reference value and/or a previous value. Alternatively, or additionally, the method can comprise determining, by the controller 210, if the rotor 106 is at an acceptable position inside the chamber 104 and/or if the distance has been reduced compared to before the cleaning was performed by comparing the received distance value to a reference distance value and/or a previous distance value. If the determination provides a positive response in any of these comparisons, the method then comprises determining, by the controller 210, that the cleaning result is satisfactory.

If the cleaning result is not satisfactory according to any or all of the above comparisons, the controller can be configured to initiate an additional cleaning process and/or send an alarm or an indication to an operator of the system that further cleaning is needed, e.g., via a user interface of the input/output device 230.

Advantageously, the improved cleaning achieved by any embodiment of the method presented in connection with FIG. 5 or 6, to be performed before the rotor 106 is reintroduced into its proper position and operation of the high-pressure feeder 100 is resumed, reduces the risk of cloggage, reduces the power needed to operate the high-pressure feeder 100, and decreases both wear and the risk of uneven wear of components of the high-pressure feeder. Wear of components will lead to a reduced lifespan of the components and by extension to a reduced lifespan of the feeder. Since the need for maintenance and replacements of system components is consequently reduced by embodiments herein, the present invention advantageously contributes to avoiding costly and time-consuming interruptions in operation, thereby saving both time and money.

The method according to any of the embodiments described in connection with FIG. 5 or 6 can further comprise measuring a fluid flow of the second flow F2 using at least one flow meter 122 operatively connected to the second conduit part 118b and receiving measurements from the at least one flow meter 122 in the controller 210.

The method can in these embodiments comprise comparing, by the controller 210, the received measurement, or several measurements received over time, from the flow meter 122 to a reference flow value (during operation, and possibly also comparing to another reference flow value during cleaning). If the measured flow value, or value over time, is lower than the respective reference value (e.g., compared to an exact desired reference value or such a reference value minus an allowable tolerance), the method can comprise determining, by the controller 210, that the second conduit part 118b is clogged. The method can then further comprise generating, by the controller 210, an alarm to an operator or the like, via a user interface of the input/output device 230 or in any suitable manner, based on such a determination.

If the fluid conduit assembly comprises a main conduit part 118 that diverges into the first and second conduit parts 118a, 118b, the method can comprise continuously measuring the second flow F2, by the at least one flow meter 122, sending the measured values to the controller 210, and determine, by the controller 210, if an adjustment of the control valve 120 is needed based on the received measurement values from the at least one flow meter 122. Determining if an adjustment of the control valve 120 is needed can be made by determining if the second flow F2 deviates from a pre-set desired flow value (either an exact value or a value including an allowed tolerance), or if a comparison between the main flow F and the second flow F2 shows that the second flow F2 deviates from a pre-set relative value compared to F, e.g. but not limited to F2=F2/2. If the determination shows that an adjustment is needed, the method can further comprise generating, by the controller 210, a control signal, sending the control signal to the control valve 120 thereby controlling it to make the adjustment, and making the appropriate adjustment by the control valve 120.

Additionally, the method can comprise receiving, in the controller 210, measurements from at least one additional flow meter arranged in connection with and operatively connected to the first conduit part 118a for measuring a fluid flow of the first flow F1 and being configured to send measurements to the controller 210. The method can in these embodiments comprise determining, by the controller 210, if the first conduit part is clogged based on measurements of the first flow F1 and comparisons to a reference value. The method in these embodiments comprises determining, by the controller 210, if adjustments of the control valve 120 is needed also based on measurements from the additional at least one flow meter. However, in embodiments wherein the fluid conduit assembly comprises the main conduit part 118, flow measurements on the first conduit part 118a are not necessary since the first flow F1 can be derived from the main flow F and the second flow F2 as long as the main flow F, the second flow F2, and the relationship between the flows F, F1 and F2 are known. Possibly, it can still be of interest to include such redundant flow meters to enable double-checking measurements performed by the at least one flow meter 122 of the second flow F2.

Variations to the disclosed embodiments can be understood and effected by those skilled in the art in practicing the claimed invention, from a study of the drawings, the disclosure, and the appended claims.

The term “comprises/comprising” when used in this specification is taken to specify the presence of stated features, integers, steps, or components. The term does not preclude the presence or addition of one or more additional elements, features, integers, steps or components or groups thereof. The indefinite article, “a” or “an”, does not exclude a plurality. In the claims, the word “or” is not to be interpreted as an exclusive or (sometimes referred to as “XOR”). On the contrary, expressions such as “A or B” covers all the cases “A and not B”, “B and not A” and “A and B”, unless otherwise indicated. The mere fact that certain measures are recited in mutually different dependent claims does not indicate that a combination of these measures cannot be used to advantage. Any reference signs in the claims should not be construed as limiting the scope.

It is also to be noted that features from the various embodiments described herein may freely be combined, unless it is explicitly stated that such a combination would be unsuitable.

The invention is not restricted to the described embodiments in the figures but may be varied freely within the scope of the claims.

1-13. (canceled)

14. A system for controlling the cleaning of a feeder housing in a high-pressure feeder, the system comprising:
a high-pressure feeder comprising a housing that comprises a tapered cylindrical chamber configured to hold a tapered cylindrical pocketed rotor, the chamber having a drive end at a drive side of the housing and an opposing tending end at a tending side of the housing;
a fluid conduit assembly operatively connected to the chamber, wherein the fluid conduit assembly comprises a first conduit part configured to transport a first flow of cleaning fluid to the chamber via the tending end of the housing and a second conduit part configured to transport a second flow of cleaning fluid to the chamber via the drive end of the housing;
a control valve arranged on the first conduit part and configured to control the first flow of cleaning fluid; and
a controller configured to receive a first input signal indicative of the initiation of a cleaning of the high-pressure feeder, and in response to the first input signal, control the control valve to reduce the first flow of cleaning fluid.

15. The system of claim 14, wherein the controller is configured to control the control valve to choke the first flow of cleaning fluid.

16. The system of the claim 14, wherein the controller is configured to receive a second input signal indicative of the cleaning process being over and, in response to the second input signal, control the control valve to increase the first flow of cleaning fluid.

17. The system of the claim 14, further comprising:
an actuator configured to move a pocketed rotor comprised in the cylindrical chamber along a longitudinal symmetry axis of the cylindrical chamber,
wherein the controller is configured to:
control the actuator to adjust the position of the pocketed rotor along the longitudinal symmetry axis, and
in response to receiving, in the controller, the first input signal during the adjustment, also control the actuator to interrupt the adjustment.

18. The system of claim 16, wherein the controller, is further configured to, in response to the second input signal, also control the actuator to continue the adjustment after controlling the control valve to increase the first flow of cleaning fluid.

19. The system of the claim 14, wherein the fluid conduit assembly further comprises a main conduit part configured to transport a main flow of liquid cleaning fluid to the chamber, wherein the main conduit part diverges into the first conduit part and the second conduit part and the main flow of cleaning liquid is thereby divided into the first flow (F1) of cleaning liquid and the second flow of cleaning liquid.

20. The system of the claim 14, further comprising a flow meter operatively connected to the second conduit part and configured to measure a fluid flow of the second flow.

21. A method for controlling the cleaning of a feeder housing in a high-pressure feeder, the high-pressure feeder comprising a housing that comprises a tapered cylindrical chamber configured to hold a tapered cylindrical pocketed rotor, the chamber having a drive end at a drive side of the housing and an opposing tending end at a tending side of the housing, wherein the chamber is operatively connected to a fluid conduit assembly comprising a first conduit part configured to transport a first flow of cleaning fluid to the chamber via the tending end of the housing and a second conduit part configured to transport a second flow of cleaning fluid to the chamber via the drive end of the housing, and wherein a control valve is arranged on the first conduit part and is configured to control the first flow of cleaning fluid, characterized in that the method comprises:
receiving, in a controller communicatively coupled to the control valve, a first input signal indicative of the initiation of a cleaning of the high-pressure feeder; and
in response to the first input signal, controlling the control valve, by the controller, to reduce the first flow of cleaning fluid.

22. The method of claim 21, wherein controlling the control valve, by the controller, to reduce the first flow of cleaning fluid comprises controlling the control valve to choke the first flow of cleaning fluid.

23. The method of the claim 21, further comprising:
receiving, in the controller, a second input signal indicative of the end of the cleaning process; and
in response to receiving the second input signal, controlling the control valve, by the controller, to increase the first flow of cleaning fluid.

24. The method of the claim 21, further comprising:
before the steps of receiving the first input signal and controlling the control valve, controlling an adjustment of the position of the tapered cylindrical pocketed rotor held in the tapered cylindrical chamber of the housing by:
controlling, by the controller, an actuator that is operatively connected to and configured to move the pocketed rotor in the cylindrical chamber along a longitudinal symmetry axis of the cylindrical chamber to adjust the position of the pocketed rotor along the longitudinal symmetry axis, and
in response to receiving, in the controller, the first input signal during the adjustment, also controlling, by the controller, the actuator to interrupt the adjustment.

25. The method of claim 23, further comprising, after controlling the control valve to increase the first flow of cleaning fluid, controlling, by the controller, the actuator to continue the adjustment in response to the second input signal.

26. The method of the claim 21, further comprising measuring a fluid flow of the second flow using a flow meter operatively connected to the second conduit part.
